(19) United States
(12) Patent Application Publication
(10) Pub. No.: US 2008/0170735 A1
(43) Pub. Date: Jul. 17, 2008

(54) RIGGING SYSTEM FOR LINE ARRAY SPEAKERS

(75) Inventors: Mark Engebretson, Encino, CA (US); Yoshiyuki Takeuchi, Pine Mountain Club, CA (US)

Correspondence Address: THE ECLIPSE GROUP, 10605 BALBOA BLVD., SUITE 300, GRANADA HILLS, CA, 91344, US

(73) Assignee: Harman International Industries, Incorporated, Northridge, CA (US)

(21) Appl. No.: 11/929,524

(22) Filed: Oct. 30, 2007

Related U.S. Application Data
(62) Division of application No. 10/407,081, filed on Apr. 3, 2003, now Pat. No. 7,298,860.
Application No. 10/407,081 is a continuation-in-part of application No. 09/921,095, filed on Jul. 31, 2001, now abandoned.
(60) Provisional application No. 60/300,372, filed on Jun. 22, 2001.
(60) Provisional application No. 60/222,026, filed on Jul. 31, 2000.

(51) Int. Cl. H04R 1/02

(52) U.S. Cl. 381/335

(57) ABSTRACT

This invention provides a system for enabling the assembly and suspension of a plurality of loudspeakers in a line allay where the splay angle between the adjacent speakers can be adjusted and rigidly maintained. The line array system utilizes rigging frames that allow for the coupling and supporting of the loudspeakers through the use of adjustable hinge bars. The rigging frames and adjustable hinge bars together form and rigidly maintain the splay angles between adjacent loudspeakers and correspondingly the curvature of the line array speaker assembly.

### CROSS-REFERENCES TO RELATED APPLICATIONS

This application is a continuation-in-part of U.S. patent application Ser. No. 09/921,095, filed Jul. 31, 2001, that claims priority to U.S. provisional application Ser. No. 60/300,372, filed Jun. 22, 2001, and U.S. provisional application Ser. No. 60/222,026, filed Jul. 31, 2000, and are incorporated by reference.

### BACKGROUND OF THE INVENTION

1. Field of the Invention

This invention relates to a rigging system for line array speakers. In particular, the invention relates to a system of assembling and suspending a plurality of line array speakers and adjusting the splay angle between the speakers to control and produce the desired sound radiation.

2. Related Art

A line array is a group of often similarly sized speakers positioned adjacent to one another to optimize sound level output over a larger coverage area. Line array speaker systems are often used in large venues, such as auditoriums and concert halls, where it is desirable to reproduce a high sound level across a wide coverage area. Line array speakers provide increased directivity at various frequencies. Providing increased directivity at various frequencies extends the near-field coverage area because the coverage distance from the near field to the far field transition zone is increased with frequency. The ability of line array speaker systems to increase near field extension is well known in the art. For this reason, line arrays offer significant advantages over traditional multi-box sound systems and are preferred for use in large venues.

To achieve an optimal sound level over a desired coverage area, line arrays are strategically positioned in various places, at varying heights and angles, throughout a venue. The positioning of the line arrays is determined by using simple equations that anticipate the performance of differently sized speakers based upon their arrangement relative to one another. The specific height of a line array and angle and spacing between the speakers in the line array are the main variables that govern the sound level output and coverage area of the line array. The height of an array governs the line array's directivity. The spacing of the individual speakers, which is a second-order effect, determines the lobbing structure of the line array. For example, a relatively straight array may radiate the sound level desired for far field coverage. For near field coverage, the line arrays often require some degree of curvature to provide uniformity of coverage over a wider vertical angle.

Once the optimal speaker arrangement for a given venue is determined, the speakers in the line arrays are then typically arranged and mounted on specially designed racks. Depending upon the desired arrangement, the line arrays are then suspended in the air with hanging equipment and/or placed on the ground. By properly arranging the line array speakers and articulating or curving the line array in the vertical plane at a specific angle, one can provide excellent coverage for listeners seated in both the near and the far fields.

Despite the advantages that line arrays can provide over traditional multi-box sound systems, there are notable disadvantages with the known line array based systems. With conventional systems, it has been difficult to adjust and maintain the splay angle between adjacent speakers. Maintaining the angles between the line array speakers, and thereby the overall curvature of the line array system, is important to the performance of the sound system. This is especially true when the line arrays are configured for large venues having more than one seating plane. With the presence of more than one seating plane, curvature becomes very important to providing uniformity of coverage and the line arrays are often suspended in the air. Depending on the particular seating arrangement, the speakers must be deployed precisely and maintained at specific vertical angles to avoid phase interference between the sounds from the adjacent loudspeakers. With the current line array systems, it has been difficult to maintain the overall integrity of the line array once suspended in the air. The conventional systems are not truly ‘rigid’ in that the specific angles between the speakers cannot be maintained constant when the system is suspended or otherwise manipulated.

Another problem associated with the current line array systems is the difficulty of assembling, suspending and adjusting the plurality of loudspeakers in an array to the desired configuration. Presently, substantial elaborate preparation and labor are required to assemble and install line array systems. The installation time and cost become significant, especially in large-scale operations, which can require many line arrays.

Another disadvantage of the conventional systems relates to the transportation of the line array systems from one location to another. The dimensions of the line array system play a significant role in determining the number of transportation vehicles needed, and consequently has a significant impact on transportation and operation costs. Many conventional sound systems utilize loudspeakers with associated frames that are more than 48 inches wide. Thus, it is impossible to vertically double stack the line array speakers with frames in an industry standard transportation type truck, which has about a 96 inch vertical cargo height. Most systems known in the art are designed without the dimensional considerations in mind to ease the actual practice of loading and transporting the systems.

Therefore, a need exists for line array speakers that are easy to assemble, transport, and suspend. In addition, a need exists for a line array system having the ability to adjust and rigidly maintain the curvature of the line array system and the splay angle between adjacent speakers.

### SUMMARY

This invention provides a system for assembling and suspending line array loudspeakers. The system further provides for the splay angles between the speakers to be easily adjusted and rigidly maintained. The line array system utilizes rigging frames that are attached to both sides of each speaker in the line array. The speakers are then coupled to one another with hinge bars that attach to and extend between the rigging frames of the speakers. The hinge bars not only support the loudspeakers but can also be easily adjusted to position the speakers at various angles relative to one another. The rigging frames and associated connecting hinge bars together form and rigidly maintain the splay angles between the speakers and correspondingly the curvature of the line array.

To form the line array, each speaker in the line array has a rigging frame attached on the left and right sides of the speaker housing. The rigging frames on each side of the speaker housing may then be coupled together with the rigging frames of adjacent speakers, such that the right rigging frame of one speaker may be coupled together with the right rigging frame of an adjoining speaker. The rigging frames are coupled to one another by front and rear hinges.

The front of the speakers in the line array are pivotally coupled together by the front hinges of the rigging frames and remain juxtaposed with respect to one another. The rear hinges are, however, adjustable and determine the splay angle between the speakers. The rear hinges can attach to the rigging frames at various points along the hinge. Thus, the angle between the speakers can be increased and decreased by connecting the rear hinges to the rigging frames at different points along the length of the hinge. The more Tinge that is exposed when connected, the greater the angle between the two adjacent speakers. The curvature of the line array system as a whole may be articulated based on the splay angles between the speakers. Thus, the splay angles between the speakers in the line array system may be adjustable to create the desired curvature and to provide smooth even sound coverage to both near and far seating areas.

Once coupled, toe line array may be either suspended in the air or stacked on the ground using one or more line array frames. Dollies and wheels may be coupled to each speaker for ease in moving and assembling the line array system.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a perspective view depicting various deployments of line array systems as they would appear positioned on a sound stage.

FIG. 2 is a perspective view illustrating an example line array speaker system.

FIG. 3 is a perspective front view of a line array speaker.

FIG. 4 is a perspective view of the rigging frame and front and rear hinge bars.

FIG. 5 is a side view of a rear hinge bar inserted between adjacent rigging frames.

FIG. 6 is a perspective view depicting the connection of two adjacent line array speaker units.

FIG. 7 is an enlarged view of the portion in FIG. 6 showing the rear hinge bar coupling the rear sides of the adjacent rigging frames.

FIG. 8 is a front view of a line array speaker.

FIG. 9 is a fi-out view of the line array speaker housing.

FIG. 10 is a top view of the speaker housing.

FIG. 11 is a cross-sectional view of the speaker housing taken along line a-a of FIG. 10.

FIG. 12 is a rear view of a typical transportation truck system loaded with the line array systems.

FIG. 13 is a perspective view of an end speaker in a line array speaker assembly having an array frame attached to the rigging frame of the speaker.

FIG. 14 is a perspective view of the line array system being assembled and lifted.

FIG. 15 is a rear perspective view of a line array speaker coupled to an alternative rigging frame on one side of the speaker.

FIG. 16 is a rear perspective view of one side of a line array speaker having a front opening and a rear opening integrated into the speaker housing.

FIG. 17 is a rear perspective view of two adjacent line array speakers that are adapted to couple to each other.

### DETAILED DESCRIPTION

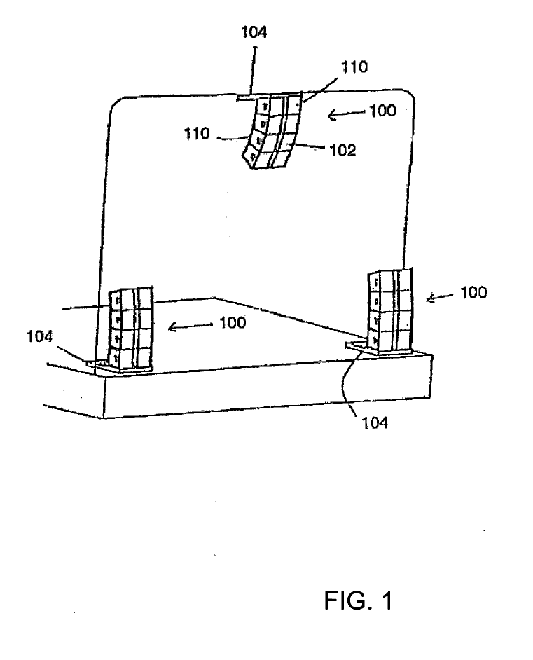

FIG. 1 illustrates a number of line array speaker systems 100 positioned on the ground, on the left and right sides of a sound stage, and suspended above the center of the sound stage. As seen in FIG. 1, each line array 100 also includes an array frame 104 that is used to hoist the line array 100 in the air or that may be used as a base support when stacked on the ground. Both the air-suspended and the ground stacked line array systems 100 may be articulated or curved to achieve the optimum sound radiation to a predetermined area.

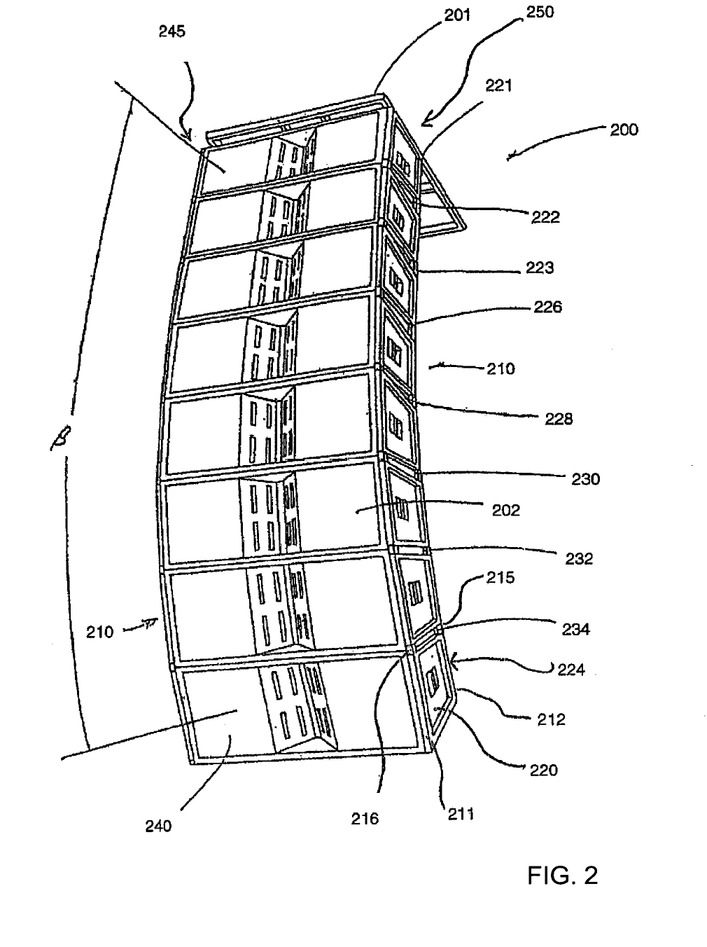

FIG. 2 is a perspective view of a hanging line array speaker system 100 and illustrates the positioning of the rigging frames 200 as they would appear on the side of each speaker 210 in the line array system 100. To form the line array system 100, each speaker 210 in the line array 100 has a rigging frame 200 coupled on die left side 245 and right side 250 of the speaker housing 220. Although the rigging frames 200 can only be seen fully on one side of the line array speakers 210 in FIG. 2, the rigging frames 200 are positioned on both the left and right sides of the array speakers 210. The rigging frames 200 may be coupled to the speaker housings 220 with machine screws set into four pads on each end of the speaker 245 and 250, or other like method of securely fastening the rigging frames 200 to the speaker housings 220.

As seen in PRIG. 2, each rigging frame 200 has a front side 211 and a rear side 212, and is substantially trapezoidal in shape. Alternatively, the rigging frames 200 may have other shapes as well, such as triangular, rectangular, etc. To form the trapezoidal shape, the front side 211 is longer than the rear side 212. Likewise, the speaker housing 220 on the left and right sides generally form a trapezoidal shape, such that the front surface 240 of the speaker housing 220 is taller than the back surface 224.

The rigging frames 200 on each side of the speaker housing 220 may then be coupled together with the rigging frames 200 of adjacent speakers 210, such that the right rigging frame 200 of one speaker 210 may be coupled together with the left rigging frame 200 of an adjoining speaker 210. The rigging frames 200 are coupled to one another by front and rear hinges 230 and 235 that attach to and extend between the rigging frames 200 of the speakers 210. The hinge bars 230 and 235 not only support the loudspeakers 210 but can also be easily adjusted, as further explained below, to position the speakers 210 at various angles relative to one another. The rigging frames 200 and associated connecting hinge bars 230 and 235 together form and rigidly maintain the splay angles between the speakers 210 and correspondingly the curvature of the line array 100. Both the rigging frames 200 and the front and rear hinges 230 and 235 may be made of heat-treated 4130 premium steel alloy, or other like material.

As seen in FIG. 2, the line array system 100 may have a predetermined curvature β to provide uniformity of coverage over a wider vertical angle. The curvature β is a summation of all the splay angles on the backside of adjacent array speakers 210. For instance, if the first splay angle 225 between the first array speaker 210 and array frame 104 is set at 0°, and each of the corresponding splay angles 222, 223, 226, 228) 233, 234, and 236 are set at 2°, 2°, 2°, 4°, 4°, 4°, and 6°, respectively, then the curvature β is 24°. Note that the front surface 240 of the line array system 100 is continuous. For example, the front sides of adjacent array speakers 210 are substantially flush against each other and there is a little gap, if any, between the two speakers 210 at their front side 240.

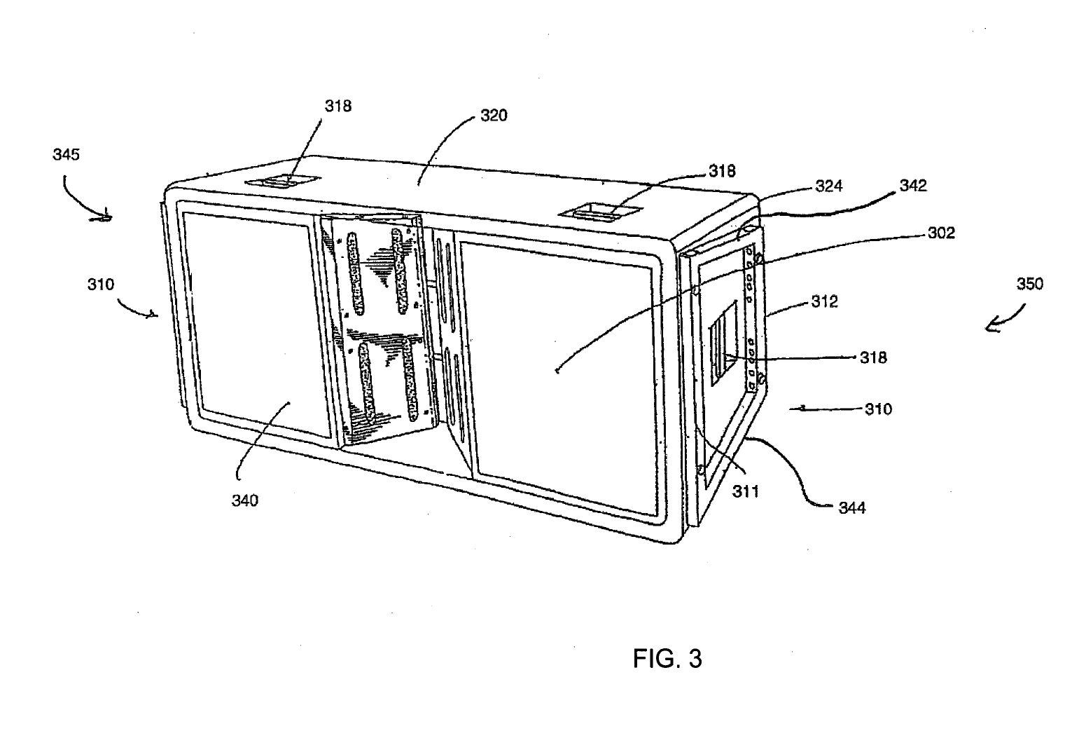

FIG. 3 is a perspective front view of a typical speaker 210 used in a line array system 100. FIG. 3 illustrates the coupling of the rigging frames 200 on the left and right side 245 and 250 of the speaker 210. FIG. 3 also illustrates the substantially trapezoidal shape of the rigging frames 200 and the speaker housing 220 and depicts the front and rear sides 211 and 212 of the rigging frames 200. To assist in handling the speaker 210, the speaker housing 220 may also include handles 310.

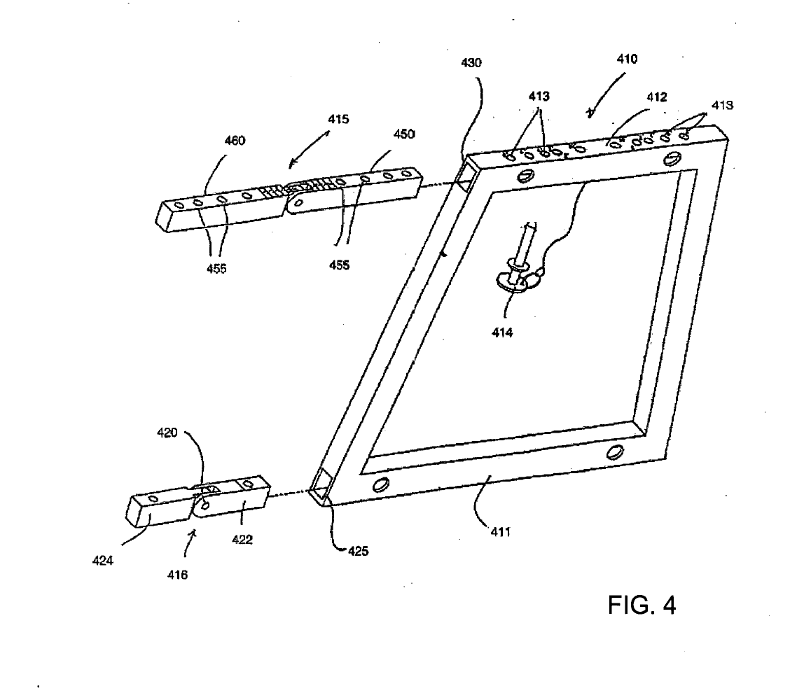

FIG. 4 is a perspective view of a rigging frame 200 and a front and rear hinge bar 230 and 235, which couple the adjacent rigging frames 200 to one another. As illustrated by FIG. 4, the front side 211 of the rigging frame 200 is adapted to slidably receive the front hinge bar 230, and the rear side 212 is adapted to slidably receive the rear hinge bar 235. The front hinge bar 230 is smaller in length than the rear hinge bar 235, and is designed to pivotally couple two adjacent front sides 211 about a pivot point 420. The pivot point 420 is provided to allow the front surfaces 240 of the speakers 210 to move relative to one another as the splay angles of the speakers 210 are adjusted.

The front hinge bar 230 has a first arm 422 and a second arm 424 coupled to one another at the pivot point 420. The first arm 422 of the front hinge bar 230 may be slidably inserted into an opening 425 in the front side 211 of the rigging frame 200 and releaseably locked in place. Similarly, the second arm 424 of the front hinge bar 230 may be slidably inserted into an opening in the front side 211 of an adjacent rigging frame 200 and releaseably locked in place. As a result, the two adjacent front sides 211 are coupled so that the front surfaces 240 of two adjacent speakers 210 are substantially flush with one another (see FIG. 2). The front hinge bars 230 may be captive in the adjacent front sides 211 with a small thumb, or slider knob (not shown) threaded through aligning holes in the front hinge bar 230 and the corresponding alms 422, 424 of the rigging frame 200 after the front hinge bar 220 is fitted into the front side 211 of the rigging frames 200. Moreover, the front hinge bar 230 may be locked into the rigging frame 200 with a release pin, similar to the release pin 435 illustrated in FIG. 4 for use in connection with the rear side 212 of the rigging frames 220. The release pins 435 may also provide a means of storage for the front hinge bars 230 so that they do not get lost or misplaced.

Similar to the front hinge bar 230, the rear hinge bar 235 has a first arm 450 and a second arm 460. The first arm 450 of the rear hinge bar 235 may be slidably inserted into an opening 430 in the rear side 212 of the rigging frame 200 and releasably locked in place. Likewise, the second arm 460 of the rear hinge bar 235 may be slidably inserted into an opening 430 in the rear side 212 of all adjacent rigging frame 200 and releaseably looked in place. As a result, the two adjacent rear sides 212 are releasably coupled to one another. The rear hinge bars 235 may be captive in the adjacent rear sides 212 with a release pin 435, which allows the positioning of the rear hinge bars 235 within the rear sides 212 of the rigging frame 200 to be easily adjusted. Unlike the front hinge bar 230, the rear lunge bar 235 has a plurality of bores 455 as well as incremental marking of degrees, ranging from 0 to 10-degrees, in 2-degree increments. Similarly, the rear side 212 of the rigging frame 200 has a plurality of openings 465, each hole marked with a specific numeric angle. By aligning the different bores 455 of the rear hinge bar 235 with different openings 465 in the rear side 212 of the rigging frame 200, the angular relationship, or the splay angles, between the adjacent line array speakers 210 may be adjusted at angles of 0 to 10-degrees. The incremental degree markings on the rear hinge bar 235 and the markings oil the openings 465 on the rear side 212 of the rigging frame 200 indicate the splay angle between the line array speakers 200 when corresponding bores 455 in the rear hinge bar 235 are aligned with the various openings 465 in the rear side 212 of the rigging frame 200.

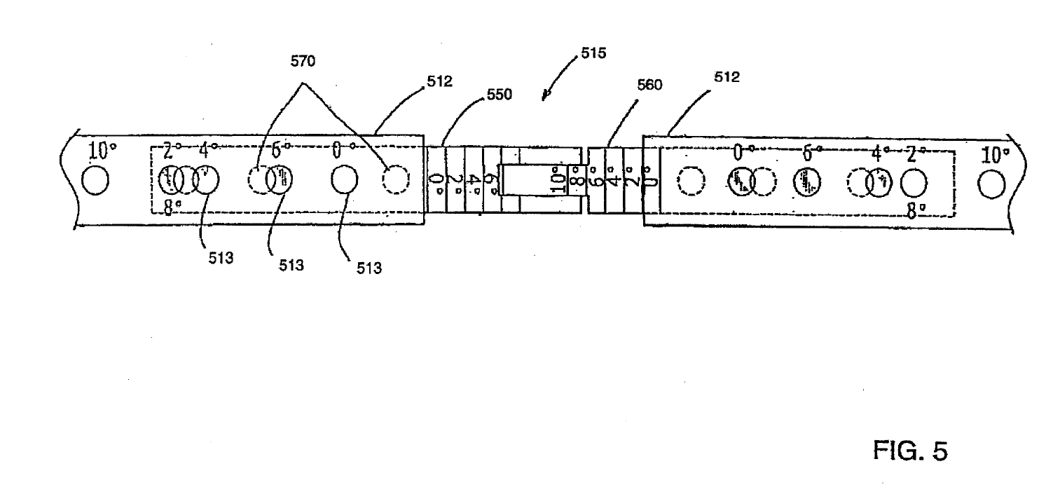

FIG. 5 is a side view of a rear hinge bar 235 inserted between adjacent rigging frames 200 and illustrates how the rear hinge bar 235 and rear side 212 of the rigging frame 200 are both marked with specific numeric angles to adjust and gauge the splay angle of the speakers 210. In FIG. 5, each of the two arms 450 and 460, of the rear hinge bar 235 may be adapted such that it can be inserted into the rear sides 212 of the rigging frames 200. As seen in FIG. 5, the plurality of bores 455 in the two arms 450 and 460 of the rear hinge bar 235, may be aligned with any of the openings 465 in the rear side 212 of the rigging frame 200 and secured against the rigging frame 200 by a release pin 435, shown in FIG. 4, positioned through the aligning bores 455 and openings 465. Depending upon which opening 465 the bore 455 is aligned, the splay angle may be set at 2-degree or 1-degree increments. As explained in more detail below, the markings on both the arms 450 and 460 and the rear side 212 of the rigging frame 200 indicate at which point the connection between the rear side 212 of the rigging frame 200 and the arms 450, 460 should be made to achieve the desired splay angle. The bores 455 in the rear hinge bar 235 and the openings 465 in the rear side 212 of the rigging frame 200 both represent coupling or connection points at which the rear hinge bar 435 and the rigging frame 200 may be coupled to one another.

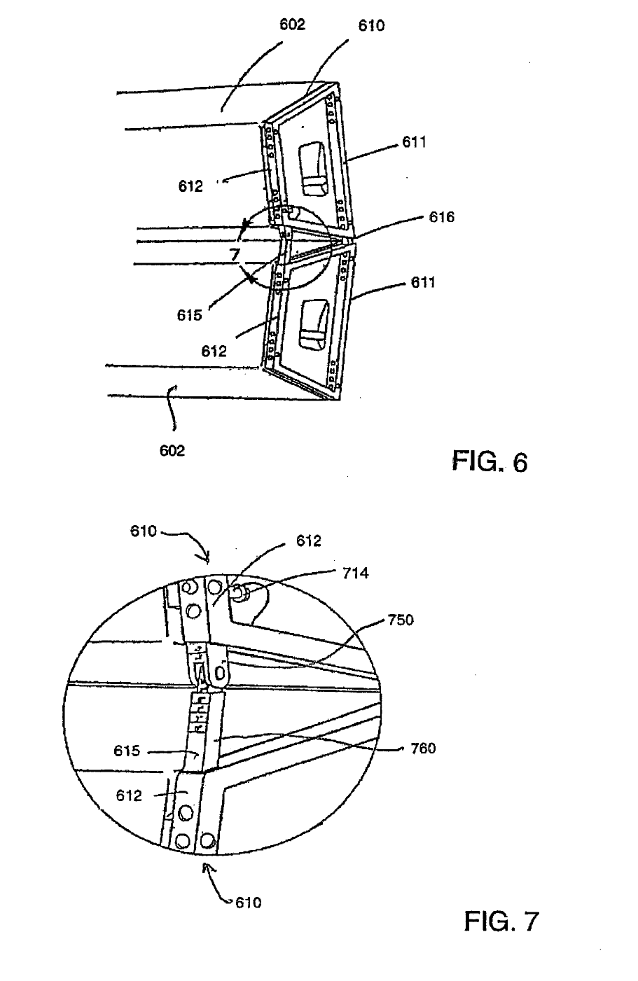

FIG. 6 is a perspective view illustrating the coupling of two adjacent line array speakers 210 and demonstrates in more detail how the rear hinge bars 235 may be utilized to adjust the splay angle between two adjacent line array speakers 210. The front hinge bar 230 may be first slidably disposed in the front side 211 of the rigging frame 200 and then pivotally coupled to the front side 211 of an adjacent rigging frame 200. Once coupled, the front sides 211 of the two adjacent rigging frames 200 remain juxtaposed without a substantial gap. Unlike the rear hinge bar 235, the front hinge bar 230 is designed to be disposed at one fixed position within the front sides 211 of the rigging frame 200. In addition, once coupled together by the front hinge bar 230, the front sides 211 of the opposing rigging frames 200 remain at the coupled position while the line array 100 is assembled, suspended, ground-stacked or otherwise manipulated.

FIG. 7 is an enlarged view of an encircled area in FIG. 6 showing how the rear hinge bar 235 couples the adjacent rear sides 212 of the rigging frames 200, and shows how each arm 450 and 460 of the rear hinge bar 235 is inserted into the adjacent rear sides 212. In FIG. 7, the splay angle 225 between the adjacent rigging frames 200 is adjusted by inserting the release pin 435 at a desired angle position. Again, by adjusting the predetermined distance between the adjacent rear sides 212 of the adjacent rigging frames 200, the splay angle 700 of the speakers 200, and the curvature of the line array system 100 is established. For instance, to set the splay angle 222 at 4-degrees, each of the arms 450 and 460 may be slidably inserted into openings 425 in the opposing rear sides 212 of adjacent rigging frames 200 until the 4-degree marking shows on both arms 450 and 460. At this position, the 4-degree opening 510 on the rear side 212 aligns with one of the bores 455 in the arm 450 so that a pill 435 may be inserted through the opening 465 and the bore 455 to couple the arm 450 to the rear side 212. To set the splay angle 222 at 1-degree, one arm 450 is inserted into the rear side 212 until the 2-degree marking shows and the other arm 460 is inserted into the rear side 212 until the 0-degree marking shows. Again, the front 230 and the rear 235 hinge bars may be stored inside of the rigging frames 200 via release pins 435 to avoid losing, misplacing or carrying loose parts.

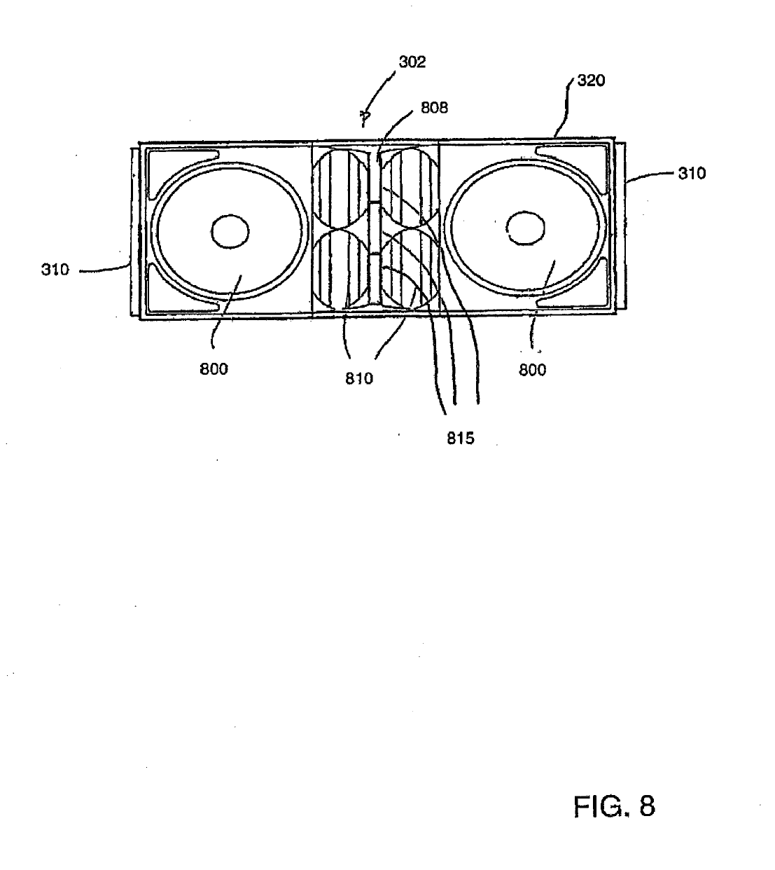

FIG. 8 is a front view of a line array speaker 210. The speaker 210 integrates the unique acoustical elements into a highly portable and rugged physical package. In one embodiment, the speaker 210 may weigh less than 72 kg while containing two 600-watt low frequency drivers 800, each having a diameter of about 15 inches. Four 300-watt mid-frequency drivers 810, each having a diameter of about 8 inches may also be included, as well as three vertically stacked 75-watt, 3-inch diaphragm high frequency compression drivers 820 each exiting through a throat opening 808 having a width of about ¾″ to about 11/4″. Each (low/mid/high) frequency driver section may be positioned on the enclosure to align with identical sections of adjacent housings 220 with minimum separation between adjacent housing driver sections so as to form a continuous ‘line’ of like driver components.

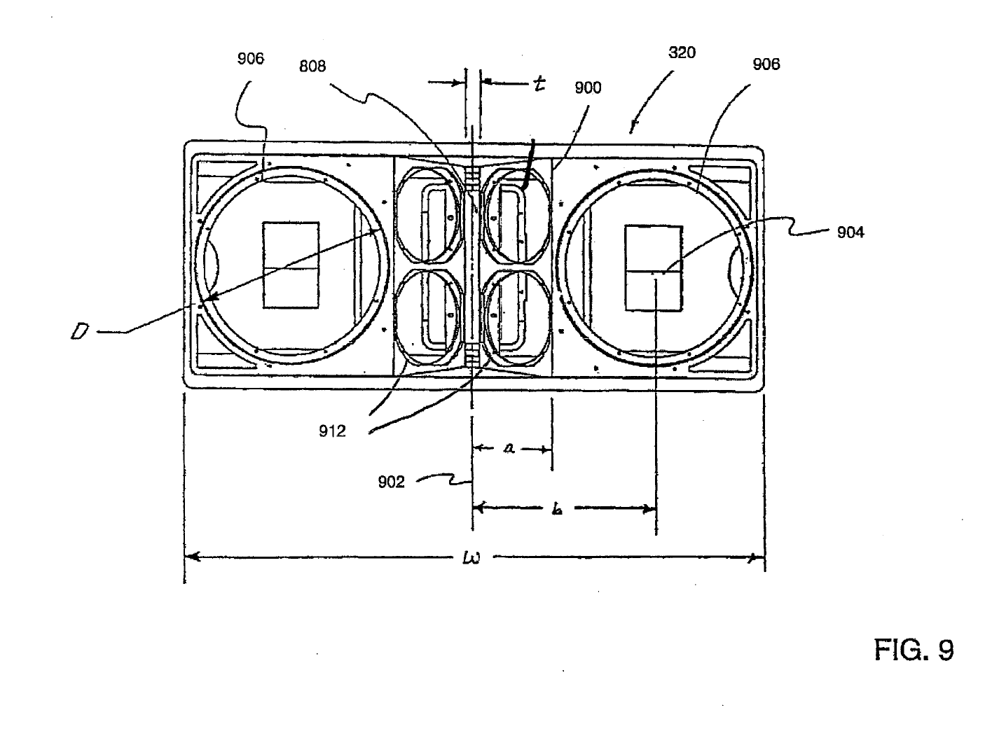

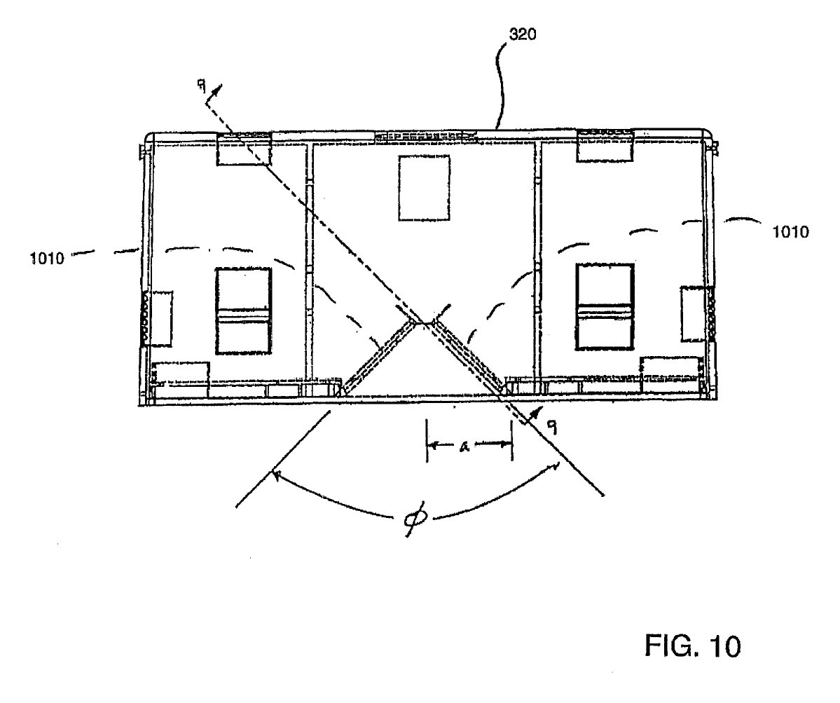

In FIGS. 9-10, the nine speakers (two 5-inch low frequency drivers 800, four 8-inch mid-frequency drivers 810, and three high frequency drivers 820) are incorporated into a speaker housing 220 that has a width “w” that is less than about 46 inches. FIG. 9 is a front view of the speaker housing 220 having the front covered removed to show an example of how the nine speakers 800, 810 and 820 would be positioned in the housing 220. As seen in FIG. 9, the speaker housing has a throat opening 808 adapted to receive three high-frequency speakers 820 stacked vertically in the center of the housing. The speaker housing 220 also has openings to receive two mid-range speakers 810 stacked vertically on each side of the high-frequency speakers 820, for a total of four mid-range speakers 810. In addition, one low range speaker 800 can be positioned on the outside of each of the vertically stacked mid-range speakers 810, for a total of two low-range speakers 800.

To configure the speakers 100 in this manner, the speaker housing 220 has a transition line 900 formed at about distance “a” from a centerline 902 and the mid-range speakers 810 are positioned in side walls 910 that are angled adjacent to one another. FIG. 10 is a top view of the speaker housing 220 of FIG. 9 and illustrates the angle φ between the adjacent sidewalls 910. In the example given in FIG. 9, if the angle φ between two adjacent side walls incorporating the mid-range drivers 810 is about 90° (see FIG. 8), then the distance (“a”) between the center line 902 and the transition line 900 may be about 6.21 inches. Moreover, the distance (“b”) between the centerline 902 and the focal point 904 for the opening 906 adapted to receive the low frequency driver 800, may be about 14.29 inches. The opening 906 may have an outer diameter (“D”) of about 15.34 inches to receive a 15-inch low frequency driver 800. For this example, the width (“t”) of the throat opening 908 may be about 1.13 inches.

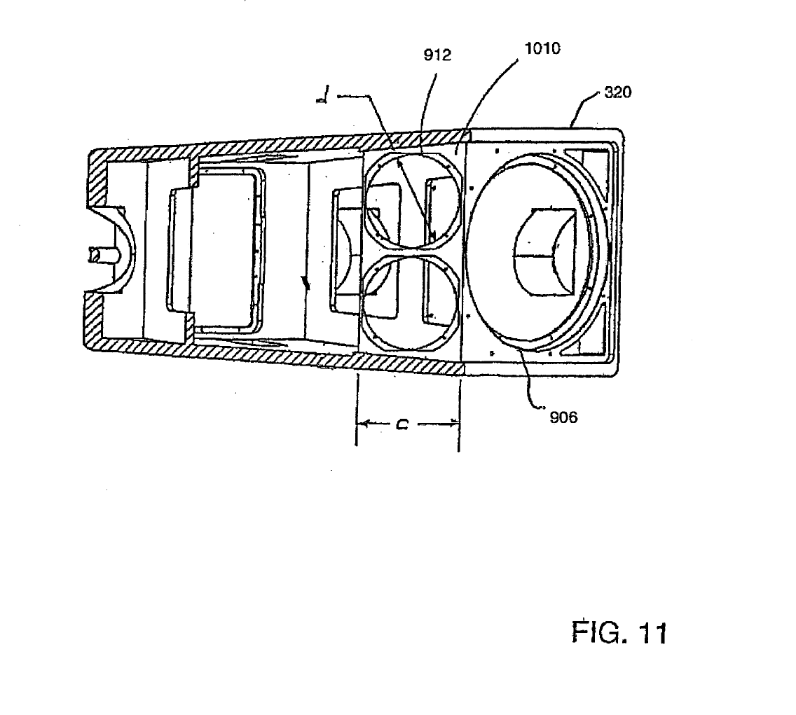

In FIG. 11, which is a cross-sectional view of the speaker housing 220 taken along line a-a of FIG. 9, if the angle φ in FIG. 8 is about 90°, then the width (“c”) of the side wall 910 adapted to receive the two mid-range frequency drivers 810 may be about 7.98 inches, and the inner diameter (“d”) for the opening 912 adapted to receive an 8-inch mid-range driver 810 may be about 7.25 inches. With the above exemplary dimensions, the width (“w”) for the speaker housing 220 may be about 45.75 inches. With the width of the rigging frames 200 (see FIG. 6) being about 1.0 inch on each side, the total width of the array speaker 210 (see FIG. 3) is less than about 48.0 inches. Depending on the angle φ between the two adjacent side walls 910, however, the total width “w” may be less than 45.75, if the angle φ is less than 90°.

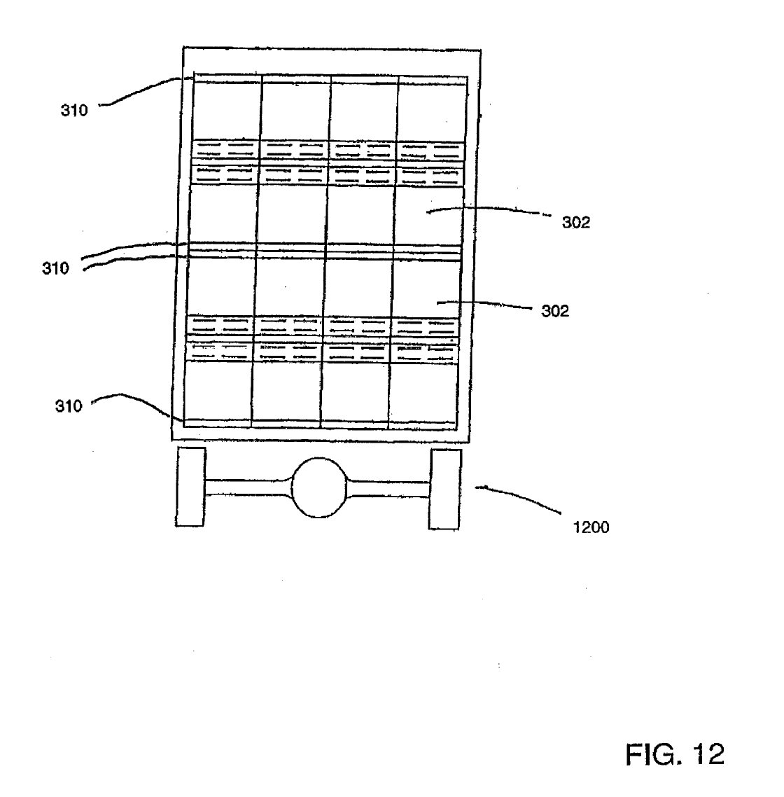

FIG. 12 is a rear sectional view of a typical transportation truck loaded with line array speakers 210 coupled with rigging frames 200 on the right side 250 and the left side 245 of the speakers 210. As previously discussed, it may be desirable to vertically double stack the line array speakers 210 (speaker 210 plus rigging frames 200 coupled) in an industry standard transport type truck having about a 96-inch vertical cargo height. As illustrated in FIG. 10, with each line array speaker 210 having a width of less than about 48 inches, it is possible to double stack the line array speakers 210 in a truck 1200 having about a 96-inch vertical cargo height, hereby reducing the number of transportation trucks 1200 needed to ship the line array speakers 210.

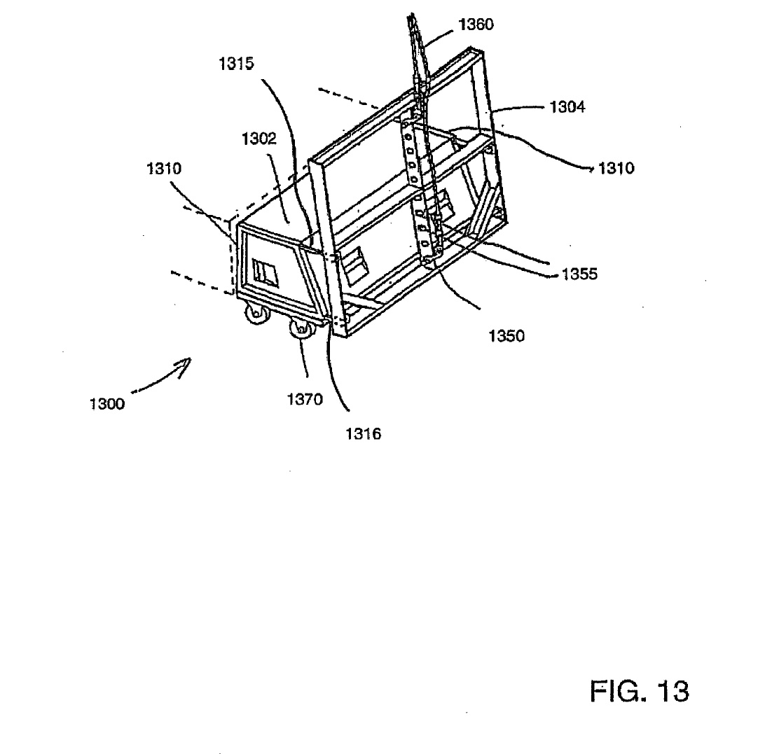

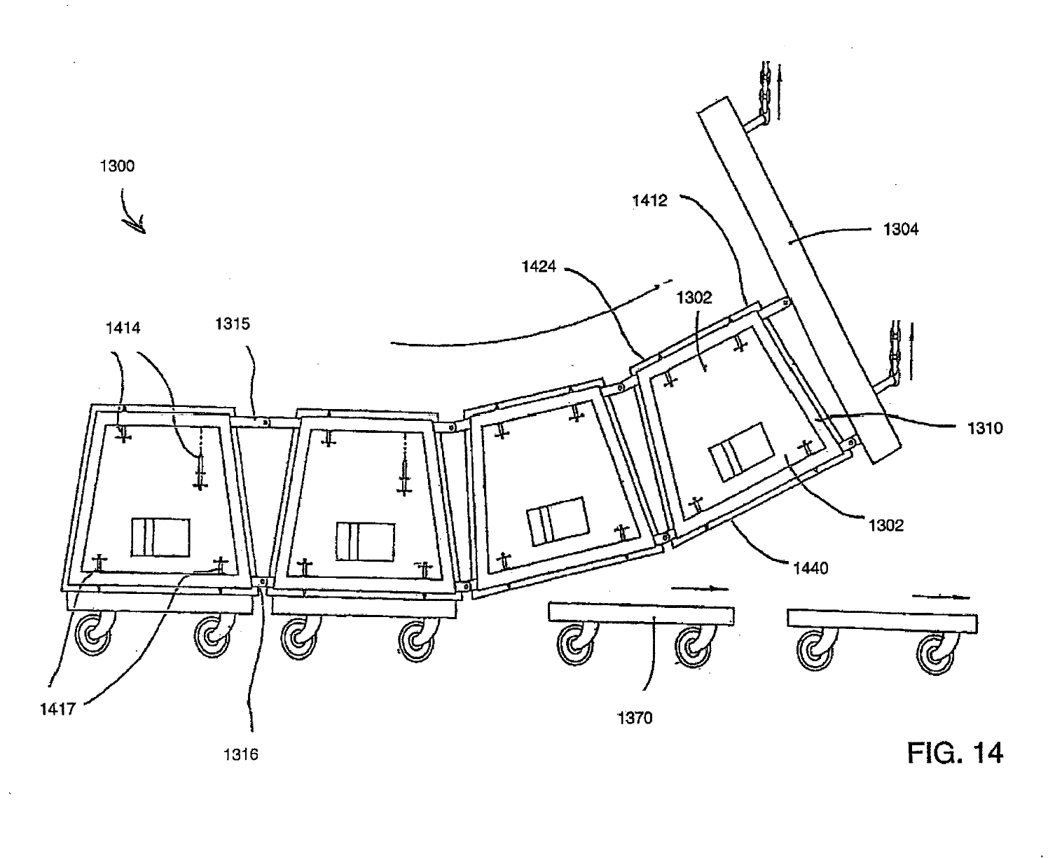

FIGS. 13 through 14 illustrate, by way of example, how the line array speakers 210 with the rigging frames 200 are moved and assembled together to be suspended in the air. FIG. 13 is a perspective view of an end speaker 210 in a line array speaker assembly 100 having an array frame 104 attached to the rigging frame 200 of the speaker 210. As seen in FIG. 13, each line array speaker 210 is provided with left and right rigging frames 200 and may further have a dolly with wheels 1300 removably attached to the bottom of each speaker 210 in the assembly 100. Additionally, an array frame 104 is positioned at a desired location, typically one at each end of the line array assembly 100, and may be attached to the rigging frame 200 through the use of the rear 235 and front 230 hinges, or in another similar manner. The array frame 104 includes front and rear receiver blocks (not shown) for coupling the hinges 235 and 230 to the array frame 104. The array frame 104 may be made of 6061 T-6 aluminum or other like material, and may include a plurality of holes (not shown) for fitting shackles 1350 in order to suspend the line array 100 in the air.

A typical line array 100 may have only one array frame 104. However, a second array frame 104 may be utilized to couple to both the top (or first) and the bottom (or the last) line array speaker 210 and suspend the line array 100 from both array frames 104. This may create an increased directivity of the line array 100. Using one or two array frames 104, the line arrays 100 may be manipulated to suspend pointing straight down or suspend at a very wide vertical angle.

To suspend a line array 100, one or more shackles 1350 are pinned in selected holes 1360 in the array frame 104. The shackles 1350 are then attached to suspension cables and one or more chain motors (not shown) are used to ultimately raise the array frame 104. If only one chain motor is used, one should select a hole in the array frame 104 that allows the array frame 104 to be balanced, taking into account the center of gravity of the line array system 100. This varies with the number of speakers 210 in the line array 100 and system configuration. A typical hanging suspension uses two chain motors.

The top or the first line array speaker 200 is attached to the array frame 104. When the array frame 104 is to be suspended, one way to assemble the line array 100 would be to first suspend the array frame 104, then attach the first (top) speaker 210 by rolling the speaker 210 up to the array frame 104. The attachment is accomplished by connecting the rear hinge bars 235 to the rear receiver blocks (not shown) on the array frame 104. Using this method, the rear hinge bars 235 may be connected first. The first speaker 210 should be set so that its baffle angle is 90 degrees in relationship to the array frame 104. This puts it in a zero-degree position. Next, the front hinge bars 230 on the first speaker 210 are attached to the front receiver blocks (not shown) of the array frame 104.

As illustrated by FIG. 14, which is a perspective view of the line array system 100 being assembled and lifted, the line array frame 104 may be lifted using the chain motor prepared to lift the first speaker 210 off the floor. The additional speakers 210 may now be moved into line and the front hinge bars 230 may be linked first. While pulling the array 104 up slightly, the rear hinge bars 235 on the additional speakers 210 may be pinned at a predetermined distance or splay angle 225 by sliding the releasing pin 435 into the desired angle bores on the rear hinge bar 235 and the matching hole on the rear side 212 of the rigging frame 200.

With the above method, additional line array speaker 200 may be added as the array 104 moves up by repeating the process of first pinning the front hinge bars 230 and then the rear hinge bars 235. As the array 104 is lifted slightly, all the fittings should be checked to ensure that the release pins 435 are in place and secure, the hinge bars 235 and 230 are set at the desired angle and the hinge bars 235 and 230 are set the same on both sides of each line array speaker 210. Also, as illustrated in FIG. 14, as the array 104 begins to go up, the dollies 1300 on the line array speaker 200 may be removed. The doily 1300 is typically equipped with a quick release latch and side handles (not shown).

There are many other ways to assemble the line array speakers 210. For example, the rear lunge bars 235 may be coupled first between the adjacent speakers 210 before connecting the front hinge bars 230. With each line array speaker unit equipped with a dolly 1300 and rigging frames 200 capable of being connected to each other by simply sliding and inserting a releasing pin 435, unloading the entire assembly 100 and suspending a line array system 100 of up to eighteen speakers 200 can be accomplished in less time, using less personnel, than it would latch to assembly a conventional line array assembly of the same size.

Additionally, are rigging frame 200 assembly may be designed of other configurations that would allow the spray angle between to adjacent speakers 210 to be adjusted. Any mechanism that will allow for the front surfaces 240 of two adjacent speakers 210 to be pivotally connected, while allowing the spray angle between the back sides of the two adjacent speakers 210 to be coupled such that the angle between the speakers 210 can be easily adjusted is within the scope of this invention.

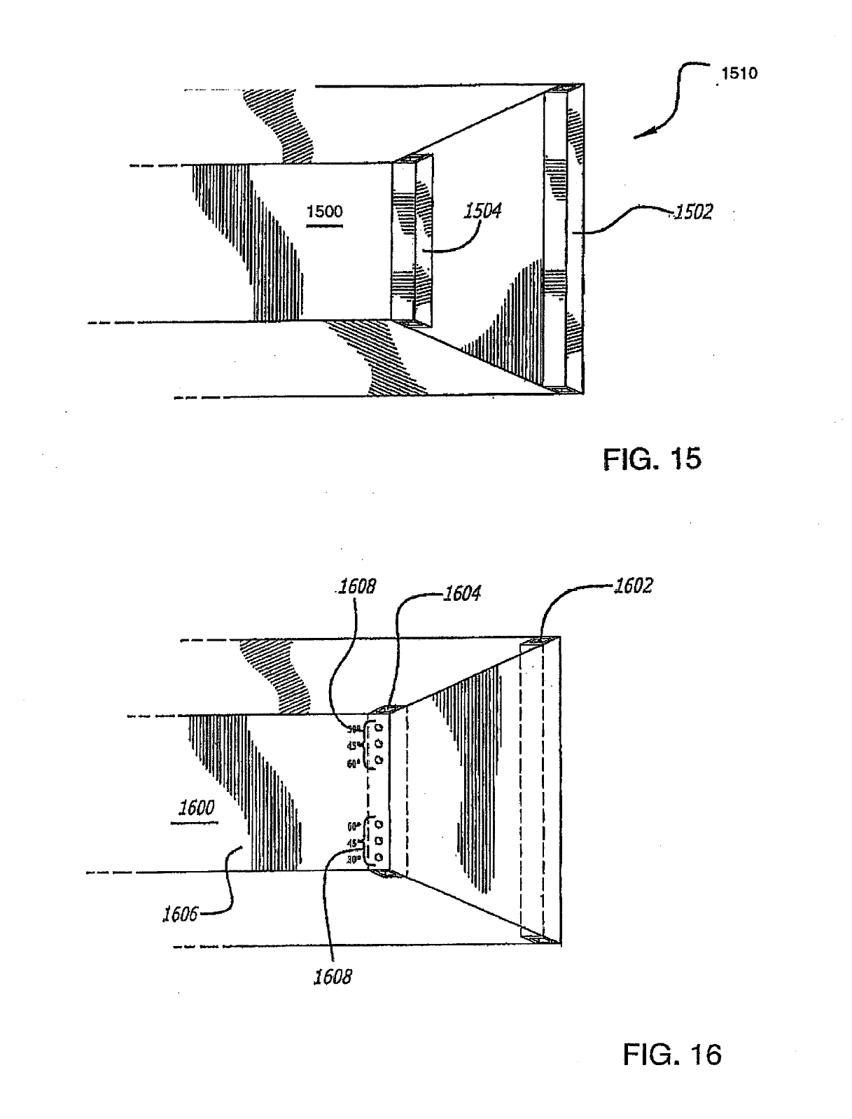

For example, FIG. 15 is a rear perspective view of a line array speaker 210 coupled to an alternative rigging frame 1500 on one side of the speaker 210. Although the rigging frame 1500 can only be seen fully on one side of the line array speaker 210 in FIG. 15, the rigging frames 1500 are positioned on both the left and right sides of the line array speaker 210. The rigging frame 1500 includes a front side 1502 and a rear side 1504 that are coupled to the side of the line array speaker 210. The front and rear sides 1502 and 1504 may be substantially similar to the front and rear sides 211 and 212 described above, respectively, without the lateral members 214 and 216 as shown in FIG. 3.

FIG. 16 is a rear perspective view of one side of a line array speaker 1600 having a front opening 1602 and a rear opening 1604 integrated into the speaker housing. The front and rear openings 1602 and 1604 are similar to the openings 425 and 430 formed on the front and rear sides 211 and 212, respectively. As such, the front and rear openings 1602 and 1604 are adapted to receive the front and rear hinge bars 230 and 235, respectively. The back side 1606 of the line array speaker 1600 has a plurality of opening 1608, where each opening is marked with a specific numeric angle similar to the plurality of openings 465 formed on the rear side 212 of the rigging frame 200 as discussed above. The front side of the line array speaker 1600 may have an opening so that a release pin may be inserted through the opening on the front side of the speaker 1600 to engage with the front hinge bar 230.

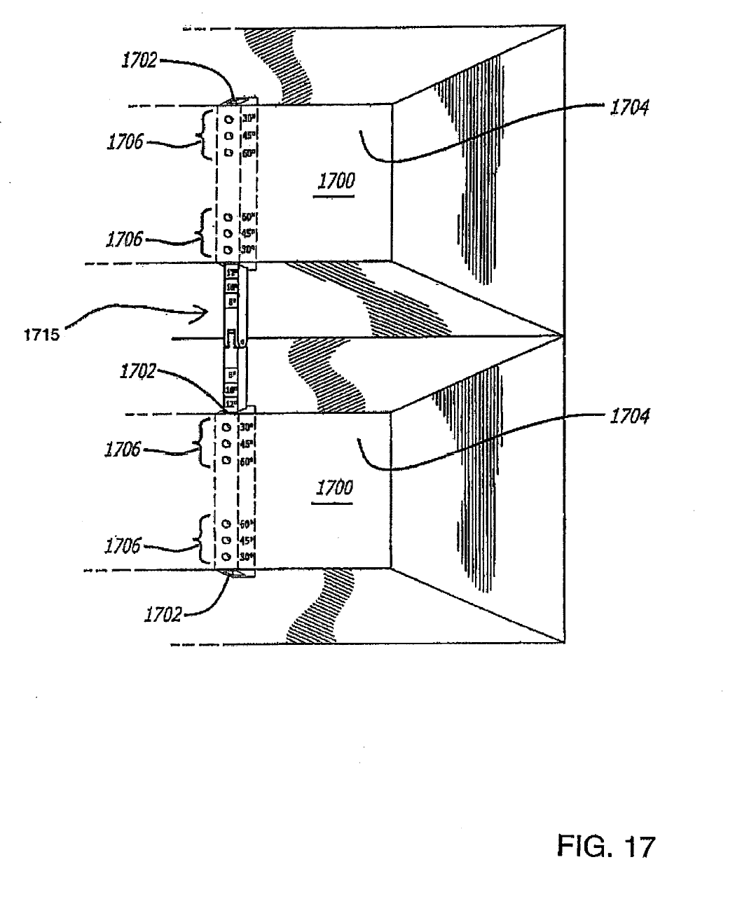

FIG. 17 is a rear perspective view of two adjacent line array speakers 1700 that are adapted to couple to each other. Each line array speaker 1700 may have an opening 1702 on the back side 1704. The opening 1702 may be formed substantially along the center or anywhere in between the left and right sides of the speaker 1700. The opening 1702 is similar to the opening 430 formed on the rear side 212 of the rigging frame 200. The back side 1704 of the speaker 1700 has a plurality of opening 1706 so that a release pin 435 may be inserted through one of the openings 1706 to engage with the rear hinge bar 235. Each opening 17076 is marked with a specific numeric angle similar to the plurality of openings 465 formed on the rear side 212 of the rigging frame 200 so that the splay angle between the two adjacent line array speakers 1700 may be adjusted as discussed above. The front sides of the two adjacent line array speakers 1700 may be pivotally coupled to each other as discussed above or any other method known to one skilled in the art.

While various embodiments of the application have been described, it will be apparent to those of ordinary skill in the art that many more embodiments and implementations are possible within the scope of this invention. Accordingly, the invention is not to be restricted except in light of the attached claims and their equivalents.

1. A rigging frame assembly, comprising:
a first frame and a second frame, each frame having a front side and a rear side;
a pivotal front hinge for removeably coupling the front side of the first frame to the front side of the second frame; and
a rear hinge for removeably connecting the rear side of the first frame to the rear side of the second frame, the rear hinge having a plurality of connection points for selectively coupling the rear sides of the first and second frames at a predetermined distance.

2. The rigging frame assembly of claim 1, where the connection points are a plurality of holes extending through the rear hinge at various points.

3. The rigging frame assembly in of claim 2, where the rear hinge is marked to indicate the resulting distance in angular measurements between the first and second frames if the rear sides of the first and second frames were to be connected to the rear hinge at each connection point.

4. The rigging frame assembly of claim 1, where the front hinge is removeably coupled to the front side of the first and second frames with a slider knob.

5. The rigging frame assembly of claim 1, where the front hinge has a pivotal point to allow for movement between the first and second frames for the coupling of the rear sides of the first and second frames at various connection points along the rear hinge.

6. The rigging frame assembly of claim 1, where the first frame is removeably attached to a side of a first speaker.

7. The rigging frame assembly of claim 6, where the second frame is removeably-attached to a side of a second speaker.

8. The rigging frame assembly of claim 1, where the first frame is part of a side of a first speaker.

9. The rigging frame assembly of claim 8, where the second frame is part of a side of a second speaker.

10. The rigging frame assembly of claim 1, where the first frame is incorporated within a first speaker.

11. The rigging frame assembly of claim 1, where the second frame is incorporated within a second speaker.

12. The rigging frame assembly of claim 1, where the first frame has a trapezoidal shape.

13. The rigging frame assembly of claim 12, where the second frame has a trapezoidal shape.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A rigging system comprising:
means for pivotally coupling front sides of two adjacent speakers; and
means for coupling the rear side of the two adjacent speakers at a predetermined distance to form a desired curvature along the front sides of the two adjacent speakers.

52. The rigging system of claim 51, further including:
means for adjusting the predetermined distance on the rear sides of the two adjacent speakers to change the desired curvature along the front sides of the two adjacent speakers.

53. The rigging system of claim 51, further including:
means for coupling each of the two adjacent speakers with at least one pair of rigging frames having a front side and a back side;
means for pivotally connecting the front sides of the two adjacent speakers with at least one front hinge bar; and
means for connecting the rear sides of the two pairs of rigging frames with at least one rear hinge bar having a plurality of coupling points for selectively coupling the rear sides of the pair of rigging frames at a predetermined distance.

54. The rigging system of claim 51, further including:
means for coupling an array frame to at least one adjacent speaker;
means for coupling a shackle to the array frame;
means for coupling a suspension cable to the shackle; and
means for raising the array frame using a chain motor.

55. The rigging system of claim 51, where the front sides of the adjacent speakers are substantially flush against each other.

56. The rigging system of claim 51, where the speaker is a line array speaker.

57. (canceled)

58. (canceled)

59. (canceled)

60. (canceled)

61. (canceled)

62. (canceled)

63. (canceled)
